(19) United States
(12) Patent Application Publication
(10) Pub. No.: US 2016/0160376 A1
(43) Pub. Date: Jun. 9, 2016

(54) Method and Electrochemical Cell for Synthesis of Electrocatalysts by Growing Metal Monolayers, or Bilayers and Treatment of Metal, Carbon, Oxide and Core-Shell Nanoparticles

(71) Applicant: BROOKHAVEN SCIENCE ASSOCIATES, LLC, Upton, NY (US)

(72) Inventors: Radoslav Adzic, East Setauket, NY (US); Junliang Zhang, Shanghai (CN); Kotaro Sasaki, Hauppauge, NY (US)

(73) Assignee: BROOKHAVEN SCIENCE ASSOCIATES, LLC, Upton, NY (US)

(21) Appl. No.: 14/946,177

(22) Filed: Nov. 19, 2015

Related U.S. Application Data
(62) Division of application No. 13/427,215, filed on Mar. 22, 2012.
(60) Provisional application No. 61/466,853, filed on Mar. 23, 2011.

(51) Int. Cl. C25D 17/18; H01M 4/88; C25D 17/12

(52) U.S. Cl. CPC C25D 17/18; C25D 17/12; H01M 4/8853

(57) ABSTRACT

An apparatus for the synthesis and treatment of electrocatalyst particles in batch or continuous fashion is provided. In one embodiment, the apparatus is comprised of a three-electrode cell which includes a cell body electrode, a reference electrode and a floating counter electrode. The floating counter electrode may be disposed inside a counter electrode compartment which is adapted to float in a slurry containing a plurality of nanoparticles and an electrolyte.

### CROSS REFERENCE TO RELATED APPLICATIONS

This application is a divisional application of application Ser. No. 13/427,215 filed Mar. 22, 2012, which claims the benefit under 35 U.S.C. 119(e) of U.S. Provisional Application No. 61/466,853 filed on Mar. 23, 2011, the content of which is incorporated herein in its entirety.

This invention was made with Government support under contract numbers DE-AC02-98CH10886 and DE-SC0012704 awarded by the U.S. Department of Energy. The Government has certain rights in the invention.

### FIELD OF THE INVENTION

This invention relates generally to an efficient, controllable synthesis, treatment and modification of low noble-metal content electrocatalysts supported on nanoparticles. The invention advantageously utilizes a specially designed cell that deposits an adlayer of a non-noble metal, such as Cu, onto nanoparticles and then displaces the non-noble metal with a monolayer of a noble-metal, such as Pt.

### BACKGROUND

Metals such as platinum (Pt), palladium (Pd), ruthenium (Ru), and related alloys are known to be excellent catalysts. When incorporated in electrodes of an electrochemical device such as a fuel cell, these materials function as electrocatalysts since they accelerate electrochemical reactions at electrode surfaces yet are not themselves consumed by the overall reaction. Although noble metals have been shown to be some of the best electrocatalysts, their successful implementation in commercially available energy conversion devices is hindered by their high cost in combination with other factors such as a susceptibility to carbon monoxide (CO) poisoning, poor stability under cyclic loading, and the relatively slow kinetics of the oxygen reduction reaction (ORR).

A variety of approaches has been employed in attempting to address these issues. One approach involves increasing the overall surface area available for reaction by forming particles with nanometer-scale dimensions. Loading of more expensive noble metals such as Pt has been further reduced by forming nanoparticles from alloys comprised of Pt and a low-cost component. Still further improvements have been attained by forming core-shell nanoparticles in which a core particle is coated with a thin shell of a different material which functions as the electrocatalyst. The core is usually a low cost material which is easily fabricated whereas the shell comprises a more catalytically active noble metal. An example is provided by U.S. Pat. No. 6,670,301 to Adzic, et al. which discloses a process for depositing a thin film of Pt on dispersed Ru nanoparticles supported by carbon (C) substrates. Another example is U.S. Patent Appl. Publ. No. 2006/0135359 to Adzic, et al. which discloses platinum- and platinum-alloy coated palladium and palladium alloy nanoparticles. Each of the aforementioned is incorporated by reference in its entirety as if fully set forth in this specification. Although these approaches have produced catalysts with a higher catalytic activity and reduced noble metal loading, realization of these enhancements on a commercial scale requires the development of large-scale and cost-effective manufacturing capabilities.

Practical synthesis of electrocatalyst particles with peak activity levels requires the development of commercially viable processes which are still capable of providing atomic-level control over the formation of ultrathin surface layers. Such a process must allow formation of uniform and conformal atomic-layer coatings of the desired material on a large number of three-dimensional particles having sizes as small as a few nanometers. One method of depositing a monolayer of Pt on particles of different metals involves the initial deposition of an atomic monolayer of a metal such as copper (Cu) by underpotential deposition (UPD). This is followed by galvanic displacement of the underlying Cu atoms by a more noble metal such as Pt as disclosed, for example, in U.S. Patent Application Publ. No. 2007/0264189 to Adzic, et al. Another method involves hydrogen adsorption-induced deposition of a monolayer of metal atoms on noble metal particles as described, for example, in U.S. Pat. No. 7,507,495 to Wang, et al. Yet another mechanism involves an apparatus and method for the synthesis and treatment of metal monolayer electrocatalyst particles in batch or continuous fashion, as described in PCT Patent Publication No. WO/2011/119818 to Adzic et al. Each of the aforementioned is incorporated by reference in its entirety as if fully set forth in this specification.

Although these processes have been successful for small-scale experiments performed in the laboratory, their commercial realization will require the development of systems and methods capable of processing a large number of electrocatalyst particles to within very tight tolerances. There, therefore, is a continuing need in the art for the development of systems and methods for synthesizing electrocatalyst particles which are commercially viable.

### SUMMARY

Having recognized the above and other considerations, the inventors determined that there is a need to develop a simple and cost-effective apparatus and process for efficient, controllable synthesis, treatment and modification of low noble-metal content electrocatalysts supported on nanoparticles. The method employs a specially designed cell that deposits an adlayer of a non-noble metal, such as Cu, onto nanoparticles and then displaces the non-noble metal with a monolayer of a noble-metal, such as Pt.

In one embodiment, the apparatus comprises a cell for synthesizing noble-metal monolayer or bilayer catalysts onto metal, alloy, core-shell, carbon, carbon-nanotube or carbon-nanohorn nanoparticles. The cell body, serving as an electrolyte container and a cathode, is designed to be in contact with the nanoparticles. The cell further comprises a reference electrode (RE), a counter electrode (CE), and a stirring controller. Additionally, the cell is adapted to maintain an atmosphere of an inert gas within the cell. The size of the cell can be made quite large with adequate power supply and can optionally contain ultrasonic equipment. The cell itself may include a counter electrode compartment containing a glass container, but is not so limited and may be any suitable container of sufficient rigidity and chemical inertness. The potential applied to the cell body is controlled by means of an external power supply. In a preferred embodiment the power supply is capable of applying a voltage in the range of −1 to +1 Volts and includes a stirring controller capable of rotating a stirrer, which can be a mechanical or magnetic stirrer, preferable a magnetic stirrer, at a rotational speed of 0 to 500 rotations per minute.

In a preferred embodiment, the cell body is made of either stainless steel or Ti sheet welded and the inside of the cell body is covered or plated with Ru or RuO₂. In this preferred embodiment, the RE is an Ag/AgCl, Cl⁻, or saturated calomel electrode, the CE is Pt foil, and the inert gas is N₂ or Ar.

In an implementation of the preferred embodiment, 5 grams of catalyst can be synthesized in one batch when the cell is 15 cm in diameter, 6 cm high, and is placed in an ultrasonic bath for increased mass transport.

In one embodiment, the method of synthesizing the nanoparticles comprises depositing a non-noble metal onto the surface of the nanoparticles, rinsing the non-noble metal ions away from the nanoparticles, contacting the nanoparticles in a second solution containing noble-metal ions, and displacing the non-noble metal with a noble-metal ions. The method of depositing a non-noble metal onto the surface of the nanoparticles comprises preparing a slurry comprising the plurality of nanoparticles and an electrolyte having a predetermined concentration of ions of a non-noble metal to be deposited as an adlayer; contacting the slurry to the apparatus for depositing a non-noble metal onto the surface of the nanoparticles; agitating the slurry and applying a predetermined potential to the cell body electrode for a predetermined duration; removing excess ions from the slurry after a first predetermined potential has been applied to the cell body electrode; adding an electrolyte having a predetermined concentration of ions of noble metal ions to the slurry; agitating the slurry and applying a second predetermined potential to the cell body electrode to facilitate deposition of the noble metal by galvanic displacement, whereby the process of galvanic displacement results in deposition of the noble metal.

In a preferred embodiment of the method, the slurry is agitated by a magnetic, mechanical, or ultrasonic agitation; the non-noble metal ions are selected from the group consisting of Cu, Pb, Bi, Sn, Ce, Ag, Sb, Tl; and a combination thereof, and the ions of the more noble metal are produced from a salt of one or more of PdCl₂, K₂PtCl₄, AuCl₃, IrCl₃, RuCl₃, OsCl₃, or ReCl₃. The application of potential can occur simultaneously with the agitation of the slurry or can follow the initial agitation.

In a more preferred embodiment, the method comprises depositing Cu, from a CuSO₄ in a H₂SO₄ solution, onto a slurry of nanoparticles. After depositing the Cu, the nanoparticles are rinsed to remove the Cu²⁺ from the solution film and the nanoparticles are placed in a K₂PtCl₄ in H₂SO₄ solution in an N₂ atmosphere. After a short immersion and displacement of Cu by Pt, the catalyst is rinsed thoroughly again.

In yet another embodiment film growth using the cell is performed in batch form. Using this approach a single batch of slurry is sequentially processed through each step of the deposition process. In still another embodiment the cell is configured for continuous operation. This approach involves feeding a continuous supply of slurry to the cell which, in turn, is operated continuously at a predetermined electrode potential and rotational speed.

The apparatus and method disclosed in this specification provide atomic-level control over film growth on a large number of particles, thereby making it suitable for commercial applications. It is especially advantageous in the production of electrocatalyst nanoparticles for use in energy conversion devices such as fuel cells, metal-air batteries, and supercapacitors.

### BRIEF DESCRIPTION OF THE DRAWINGS

FIG. 1 depicts the components of a cell for synthesis of electrocatalysts.

FIG. 2 shows a series of images illustrating the underpotential deposition of an adlayer onto the surface of a core-shell nanoparticle followed by galvanic displacement by a more noble metal.

FIG. 3 is an atomic-scale cross-sectional schematic of a core-shell nanoparticle encapsulated by a monolayer of a catalytically active metal.

FIG. 4 is a flowchart showing the sequence of steps performed during film growth using the cell.

### DETAILED DESCRIPTION

These and other aspects of the invention will become more apparent from the following description and illustrative embodiments which are described in detail with reference to the accompanying drawings. In the interest of clarity, in describing the present invention, the following terms and acronyms are defined as provided below.

### Acronyms

MWNT: Multi-walled nanotube

NHE: Normal hydrogen electrode

ORR: Oxidation reduction reaction

SWNT: Single-walled nanotube

UPD: Underpotential deposition

CBE: Cell Body Electrode

RE: Reference Electrode

CE: Counter Electrode

### Definitions

Adatom: An atom located on the surface of an underlying substrate.

Adlayer: A layer of atoms or molecules adsorbed onto the surface of a substrate.

Bilayer: Two consecutive layers of atoms or molecules which occupy available surface sites on each layer and coat substantially the entire exposed surface of the substrate.

Catalysis: A process by which the rate of a chemical reaction is increased by means of a substance (a catalyst) which is not itself consumed by the reaction.

Electrocatalysis: The process of catalyzing a half cell reaction at an electrode surface by means of a substance (an electrocatalyst) which is not itself consumed by the reaction.

Electrodeposition: Another term for electroplating.

Electroplating: The process of using an electrical current to reduce cations of a desired material from solution to coat a conductive substrate with a thin layer of the material.

Monolayer: A single layer of atoms or molecules which occupies available surface sites and covers substantially the entire exposed surface of a substrate.

Multilayer: More than one layer of atoms or molecules on the surface, with each layer being sequentially stacked on top of the preceding layer.

Nanoparticle: Any manufactured structure or particle with at least one nanometer-scale dimension, i.e., 1-100 nm

Nanostructure: Any manufactured structure with nanometer-scale dimensions.

Noble metal: A metal that is extremely stable and inert, being resistant to corrosion or oxidation. These generally comprise ruthenium (Ru), rhodium (Rh), palladium (Pd), silver (Ag), rhenium (Re), osmium (Os), iridium (Ir), platinum (Pt), and gold (Au). Noble metals are frequently used as a passivating layer.

Non-noble metal: A transition metal which is not a noble metal.

Redox reaction: A chemical reaction wherein an atom undergoes a change in oxidation number. This typically involves the loss of electrons by one entity accompanied by the gain of electrons by another entity.

Refractory metal: A class of metals with extraordinary resistance to heat and wear, but with generally poor resistance to oxidation and corrosion. These generally comprise tungsten (W), molybdenum (Mo), niobium (Nb), tantalum (Ta), and rhenium (Re).

Slurry: A suspension of solids in a liquid.

Submonolayer: Surface atomic or molecular coverages which are less than a monolayer.

Transition metal: Any element in the d-block of the periodic table which includes groups 3 to 12.

Trilayer: Three consecutive layers of atoms or molecules which occupy available surface sites on each layer and coat substantially the entire exposed surface of the substrate.

Underpotential Deposition: A phenomenon involving the electrodeposition of a species at a potential which is positive with respect to the equilibrium or Nernst potential for the reduction of the metal.

This invention is based on the development of an apparatus and method for the deposition of atomically thin films on a large number of particles in batch or continuous fashion. The apparatus, which is described as a cell throughout this specification, has a cell body that serves as an electrolyte container and a cathode that is in contact with the slurry. Continuous movement of the slurry is driven by a stirrer to induce collisions between the cell body electrode (CBE) surface and particles contained within the slurry. By application of the appropriate electrical potential, particles that come into contact with the CBE acquire the charge necessary for an atomic layer of the desired material to deposit by underpotential deposition (UPD). The continuous motion of the slurry, and the large surface area of the cell body ensure that uncoated particles within the slurry continually come into contact with the CBE to form the desired adlayer.

After substantially all of the particles have been coated with an initial adlayer, the excess metal ions in solution are removed and a catalytically active surface layer is formed by exposing the particles to a salt of a metal which is more noble than the adlayer. Deposition of the catalytically active surface layer then occurs by galvanic displacement of the UPD adlayer by the more noble metal salt. The apparatus can conceivably be used with any type, size, and shape of particle which can be formed into a slurry and undergo film growth by UPD, as a result of contacting an electrode having an applied potential. Regardless of the type of particle used as the substrate, the apparatus is suitable for commercial manufacturing processes since it facilitates the controlled deposition of ultrathin films with atomic-level control on a large number of these particles in batch or continuous fashion.

### I. Particle Synthesis

Particles of carbon, a suitable metal, metal alloy, core-shell, carbon, carbon-nanotube, or carbon-nanohorn are initially prepared using any technique which is well-known in the art. It is to be understood, however, that the invention is not limited to deposition onto metal or carbon-based particles and may include other materials which are well-known in the art including semiconductors. It is these particles onto which a thin film of the desired material will be deposited. The particles are preferably nanoparticles with sizes ranging from 2 to 100 nm in one more dimensions. However, the size is not so limited and may extend into the micrometer and millimeter size range.

In one embodiment, the nanoparticles comprise a metal, metal alloy, and/or core-shell particles. It is also to be understood that the metal, metal alloy, and/or core-shell particles may take on any shape, size, and structure as is well-known in the art including, but not limited to, branching, conical, pyramidal, cubical, mesh, fiber, cuboctahedral, and tubular nanoparticles. The nanoparticles may be agglomerated or dispersed, formed into ordered arrays, fabricated into an interconnected mesh structure, either formed on a supporting medium or suspended in a solution, and may have even or uneven size distributions. The particle shape and size is preferably such that the bonding configuration of surface atoms is such that their reactivity and, hence, their ability to function as a catalyst is increased.

In another embodiment the nanoparticles are in the form of nanostructured carbon substrates. Examples of carbon nanostructures include, but are not limited to carbon nanoparticles, nanofibers, nanotubes, fullerenes, nanocones, and/or nanohorns. Within this specification, the primary carbon nanostructures discussed are carbon nanotubes and nanohorns. However, it is to be understood that the carbon nanostructures used are not limited to these particular structures. Carbon nanotubes are identified as nanometer-scale cylindrical structures of indeterminate length comprised entirely of sp²-bonded carbon atoms. The nanotube may be a single-walled nanotube (SWNT) or a multi-walled nanotube (MWNT). A higher specific surface area may be obtained using carbon nanohorns which have a structure analogous to nanotubes, but with one end of the cylindrical tube closed and the other open, resulting in a horn-like shape. Carbon nanohorns generally possess a higher specific surface area than carbon nanotubes and an average pore size (on the order of tens of nm) which is larger than both carbon nanotubes and activated carbon or carbon fibers.

This specification discloses film growth on nanoparticles as an embodiment which exemplifies the spirit and scope of the present invention. It is to be understood, however, that any suitable particle as described above may be used with the apparatus. Methods for producing the various types of nanoparticles and depositing ultrathin surface layers by UPD and galvanic displacement has been previously described in U.S. Patent Appl. Publication No. 2010/0216632 to Adzic et al., which is incorporated by reference in its entirety as if fully set forth in this specification. Production of carbon nanostructures and depositing ultrathin surface layers by UPD and galvanic displacement have previously been described in U.S. Patent Appl. Publication No. 2010/0177462 to Adzic et al., which is incorporated by reference in its entirety as if fully set forth in this specification.

### II. Ultrathin Film Growth

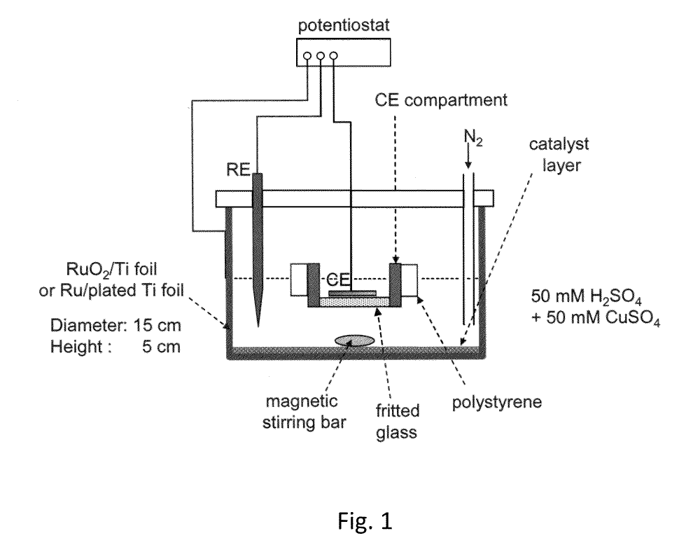

Once nanoparticles having the desired shape, composition, and size distribution have been fabricated, it is necessary to produce a suspension or slurry of these particles so that the desired ultrathin films may then be deposited. Film growth is accomplished by UPD using a cell, an embodiment of which is illustrated in FIG. 1. The cell permits the controllable deposition of ultrathin films having thicknesses in the submonolayer-to-multilayer thickness range onto a large number of particles in batch or continuous fashion.

For purposes of this specification, a monolayer is formed when the substrate surface is substantially fully covered by a single layer comprising adatoms which form a chemical or physical bond with the atoms of the underlying substrate. If the surface is not substantially completely covered, e.g., substantially fewer than all available surface sites are occupied by an adatom, then the surface coverage is termed submonolayer. However, if additional layers are deposited onto the first layer, then multilayer coverages result. If two successive layers are formed, then it is termed a bilayer and if three successive layers are formed, then the resultant film is a trilayer and so on. The materials chemistry underlying the present invention may be best understood through an initial description of the cell. This is followed by a description of the principles governing growth by underpotential deposition.

### A. Cell

The structure of a cell is illustrated in FIG. 1. In a preferred embodiment the cell comprises three electrodes which are identified as the cell body electrode (CBE), which with the catalyst layer represents a working electrode (WE), a reference electrode (RE), and a “floating” counter electrode (CE). The cell body is in contact with the slurry, while the RE and CE are immersed in the cell containing a slurry comprised of the desired particles in an electrolyte. The cell can also contain a CE compartment including a glass container, but can be constructed of any material which is electrically insulating and is capable of holding solutions of a corrosive nature.

The CBE may cover the entire inner surface of the cell or, alternatively, can cover just a portion of the inner surface of the cell. In one embodiment, the entire inner surface of the cell body is covered with an electrically conductive material. In another embodiment, the bottom inner surface of the cell body is covered with an electrically conductive material. Some examples of electrically conductive materials which may be used as the CBE include titanium (Ti) activated by a ruthenium (Ru) coating, stainless steel, and glassy carbon.

The cell is also provided with an external power supply (potentiostat) and stirring controller and a magnetic stirring bar. In addition to, or in place of, the stirring controller, the cell can comprise other equipment for agitating or stirring the slurry, such as ultrasonic equipment or mechanical stirrers or mixers. The power supply is capable of applying the desired electrical potential to the electrodes. Some typical operating parameters include a stirring speed of between 0 to 500 rotations per minute (rpm) and an applied potential of −1 to +1 Volts. In a preferred embodiment, the stirring speed is between 10 and 200 rpm. The actual parameters used, of course, depend upon the particular size and configuration of the cell as well as the constituents of the slurry.

The reaction of interest occurs between the slurry and the exposed surfaces of the CBE. The half-cell reactivity of the slurry can be measured by varying the potential applied to the CBE and then measuring the resulting current flow. The CE serves as the other half of the half-cell and balances the electrons which are added or removed at the CBE. In order to determine the potential of the CBE, the potential of the CE must be known. Completion of the redox reactions occurring at the exposed surfaces of the CBE requires that a constant potential be maintained at both electrodes while the necessary current is permitted to flow. In practice this is difficult to accomplish using a two-electrode system. This issue may be resolved by introducing the RE to divide the role of supplying electrons and maintaining a reference potential between two separate electrodes. The RE is a half cell with a known reduction potential. It acts as a reference in the measurement and control of the potential of the CBE. The RE does not pass any current to or from the electrolyte; all current needed to balance the reactions occurring at the CBE flows through the CE.

The sole purpose of the CE is to permit the flow of electrical current from the slurry. Consequently, the CE can be nearly any material as long as it is a good conductor and does not react with the electrolyte. Most CEs are fabricated from Pt wire since Pt is a good electrical conductor and is electrochemically inert. The wire may be of any thickness, but it is typically thin. The RE has a stable and well-known electrode potential which is usually attained by means of a redox system having constant concentrations of each participant in the redox reaction. Examples include a normal hydrogen electrode (NHE) or a silver-silver chloride (Ag/AgCl) reference electrode. The RE provides a reference potential for the reaction to be carried out.

In a typical setup, the CBE, RE, and CE of the cell are static and the desired slurry is stirred with a magnetic stirrer which driven by a stirring controller. This stirring provides a flux of particles toward and on the CBE and therefore facilitates collisions between particles in the slurry and the CBE where they come into electrical contact and are given the charge necessary to facilitate film growth. The stirring speed is chosen such that the flux of incoming and outgoing particles is balanced and the probability of electrical contact between the CBE and the particles is maximized. Preferred stirring speeds typically range from 10 to 200 rpm. The electrochemical reactions occurring through the exposed surface of the CBE can be controlled and analyzed by varying the electrode potential with time and measuring the resulting current flow. The potential is measured between the RE and the CBE whereas the current is measured between the CBE and the CE.

The applied potential can be changed linearly with time such that oxidation or reduction of species at the electrode surface can be analyzed through changes in the current signal as is typically performed during linear voltammetry measurements. Although the applied potential preferably ranges from −1 to +1 volts, the exact potential range used depends on the specifics of a particular configuration, including parameters such as the type of particles and UPD element. As an example, for the UPD of Cu, the applied potential typically ranges from 0.05 to 0.5 V versus a silver/silver chloride (Ag/AgCl, Cl⁻) RE. Oxidation is registered as an increase in current whereas reduction results in a decrease in the current signal. The resultant peaks and troughs can be analyzed and information on the kinetics and thermodynamics of the system can be extracted. If the slurry is redox active it may display a reversible wave in which the slurry is reduced (or oxidized) during a linear sweep in the forward direction and is oxidized (or reduced) in a predictable manner when the potential is stopped and then swept in the reverse direction such as during cyclic voltammetry.

In conventional electrodeposition a cation contained in solution is reduced by the flow of electrical current through a conductive substrate. At the substrate surface, electrons combine with and thereby reduce cations in solution to form a thin film on the surface of the substrate itself. In order for the overall reaction to proceed, the reduction of cations at one electrode must be counterbalanced by oxidation at a second electrode. In a standard electroplating setup the part to be plated is the cathode whereas oxidation occurs at the anode. The cathode is connected to the negative terminal of an external power supply whereas the anode is connected to the positive terminal. When the power supply is activated, the material constituting the anode is oxidized to form cations with a positive charge whereas cations in solution are reduced and thereby plated onto the surface of the cathode. The cathode and anode in an electroplating cell are analogous to the CBE and CE, respectively, in the three-terminal cell of FIG. 1.

For conventional metals there is generally a bulk deposition potential (or Nernst potential) which is necessary for deposition of the metal itself to proceed. It is known that for certain metals it is possible to deposit a single monolayer or bilayer of the metal onto a substrate of a different metal at potentials positive to the bulk deposition potential. In this case, formation of the metal monolayer occurs before bulk deposition can proceed. This phenomenon is known as underpotential deposition (UPD) and it occurs when the adatom-substrate bonding is stronger than the adatom-adatom bonding. An example is provided by Brankovic, et al. which discloses the use of UPD to form an adlayer of Cu onto Pd substrates in “Metal Monolayer Deposition by Replacement of Metal Adlayers on Electrode Surfaces,” Surf. Sci., 474, L173 (2001) which is incorporated by reference in its entirety as if fully set forth in this specification. The process used to form adlayers by UPD is generally reversible. By sweeping the applied potential in one direction, a monolayer of the desired material may be deposited whereas a sweep in the reverse direction results in desorption of the thus-formed monolayer.

When contact is made between the CBE and the slurry, charge is transferred from the CBE to the particle such that metal ions in solution are reduced and deposited onto the surface of the particle by UPD. The continuous stirring action agitates the slurry such that uncoated particles continuously come into contact with the CBE. In this manner, a thin film can be deposited onto substantially all of the particles in a single batch. When one batch is complete, the nanoparticles can be removed from solution, rinsed, and a new batch comprising another batch of slurry having uncoated particles can be added to the solution. Alternatively, when one batch is complete, the solution can be removed, the nanoparticles rinsed, and a new solution can be introduced into the cell. The overall size of the cell determines the quantity of particles that can be processed in a single batch of 200 ml to 2000 ml. A typical configuration is capable of processing 1 to 20 grams of particles in a single batch, but quantities are not so limited. In another embodiment, it is conceivable that the slurry could be continuously fed into and out of the cell where particles contained in the slurry come into contact with the CBE so that an ultrathin film can be deposited.

### B. Underpotential Deposition and Galvanic Displacement

Having described the structure, function, and operation of the cell, processes by which the cell may be used to deposit ultrathin films will now be described in detail. The deposition process is centered around a series of electrochemical reactions which, when performed sequentially result in an ultrathin film with the targeted surface coverage. In one embodiment, the procedure involves the initial formation of an adlayer of a material onto the surface of the particles by UPD. This is followed by the galvanic displacement of the adlayer by a more noble metal, resulting in the conformal deposition of a layer of the more noble metal on the substrate. It is to be understood, however, that although the cell is particularly advantageous for use during UPD growth, it is not limited to this particular growth technique and may be used for other electrochemical processes such as electroplating.

### Example 1

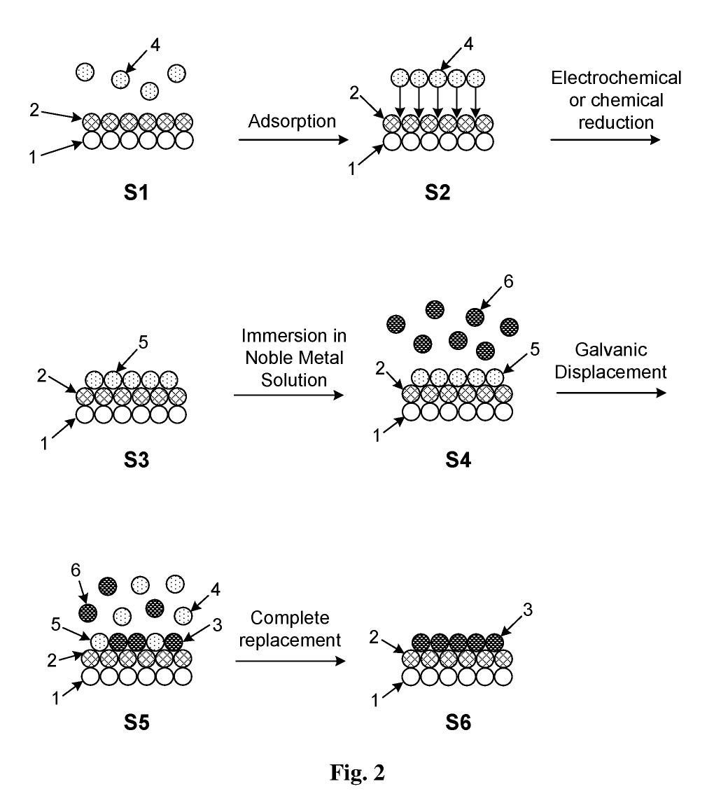

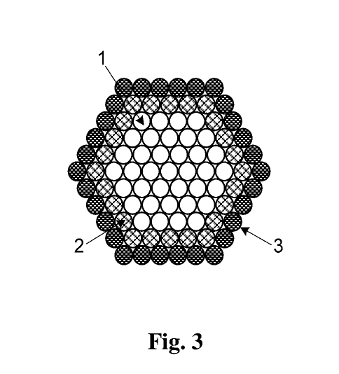

The present apparatus and process may be illustrated by way of exemplary embodiments. In this example, the deposition process will be described with reference to deposition onto non-noble metal-noble metal core-shell nanoparticles. The core-shell nanoparticles may be initially formed using any method known in the art including, for example, those disclosed in U.S. Patent Appl. Pub. No. 2010/0216632. The deposition process in Example 1 will now be described using FIGS. 2 and 3 as a reference. The nanoparticle surface in FIG. 2 shows a portion of the non-noble metal core (1) along with the noble metal shell (2). Non-noble metal ions (4) are initially adsorbed on the surface by immersing the nanoparticles in a cell comprising the appropriate concentration of non-noble metal ions (4) in step S1. The non-noble metal (4) ions are contained in solution within the slurry illustrated in FIG. 1. Typical non-noble metal ions that may be used for UPD of an initial adlayer include, but are not limited to, copper (Cu), lead (Pb), bismuth (Bi), tin (Sn), cadmium (Cd), silver (Ag), antimony (Sb), and thallium (Tl). In this preferred embodiment, the non-noble metal ion solution is 50 mM CuSO₄ in a 50 mM H₂ SO₄ solution.

By stirring the slurry at 50 rpm stirring rate and applying the appropriate potential of 0.15 V, film growth by UPD occurs whenever a core-shell particle contacts the exposed surface of the CBE and acquires the charge necessary for UPD. This leads to the adsorption of metal ions (4) on the nanoparticle surface in step S2 and the formation of a monolayer of the non-noble metal (5) in step S3. This monolayer forms a substantially continuous “skin” around the periphery of the core-shell nanoparticle. It is to be understood, however, that whether the initial UPD adlayer achieves submonolayer or monolayer surface coverages depends on the duration of the contact between the particle and the CBE as well as the applied potential. The duration of the contact is influenced by a number of factors including the stirring rate, the shape and size of the particle, the viscosity of the slurry, and whether deposition proceeds in batch or continuous fashion. Although the reaction itself is fast, these other factors generally require that the process continue for 10 to 20 minutes and up to about 2 hours.

After formation of an initial non-noble metal adlayer by UPD is complete, the non-noble metal ions remaining in solution are removed by rinsing with deionized water. This helps to remove excess non-noble metal ions (4) present on the surfaces of the particles. The particles are typically maintained under a nitrogen or other inert atmosphere during transfer to inhibit oxidation of the freshly deposited non-noble metal adlayer (5). A solution comprising a salt of a more noble metal is added in step S4 where the more noble metal ions (6) contained in solution replace surface non-noble metal adatoms (5) via a redox reaction as illustrated in step S5. The more noble metal (6) acts as an oxidizing agent by accepting electrons from the non-noble metal. The simultaneous reduction of the more noble metal ions (6) to an adlayer of the more noble metal (3) results in the replacement of surface non-noble metal atoms (5) with the more noble metal atoms (3). For example, monolayers of a noble metal such as palladium, platinum, gold, iridium, ruthenium, osmium, or rhenium can be deposited by displacement of a less noble metal using salts of PdCl₂, K₂PtCl₄, AuCl₃, IrCl₃, RuCl₃, OsCl₃, or ReCl₃, respectively. The galvanic displacement process may be performed separately, within the same or a different cell. When performed in the cell, agitation of the solution can be facilitated by stirring the slurry at a predetermined stir speed using the magnetic stirrer/controller 50 rpm. In this preferred embodiment, the noble metal ion solution is 1.0 mM K₂PtCl₄ in a 50 mM H₂SO₄ solution.

The final product is a core-shell nanoparticle with a “skin” comprising a monolayer of the more noble metal atoms as shown in step S6 and illustrated in FIG. 3. The encapsulated core-shell nanoparticle cross-section in FIG. 3 shows that all atoms are close-packed in a hexagonal lattice, resulting in a hexagonal shape. It is to be understood, however, that the crystallographic structure is not limited to that shown and described in FIG. 3. The cycle depicted in FIG. 2 may be repeated any number of times to deposit additional layers of the more noble metal (3) onto the surface of the core-shell nanoparticle to ensure complete coverage. Conversely, less than a monolayer of the non-noble metal (5) may be deposited during UPD such that submonolayer coverages of the noble metal (3) result. While only a portion of the surface of a single core-shell nanoparticle is illustrated in FIG. 2, it is to be understood that deposition occurs simultaneously on a large number of core-shell nanoparticles. The “skin” of atoms forms a continuous and conformal coverage of the entire available surface area of each nanoparticle.

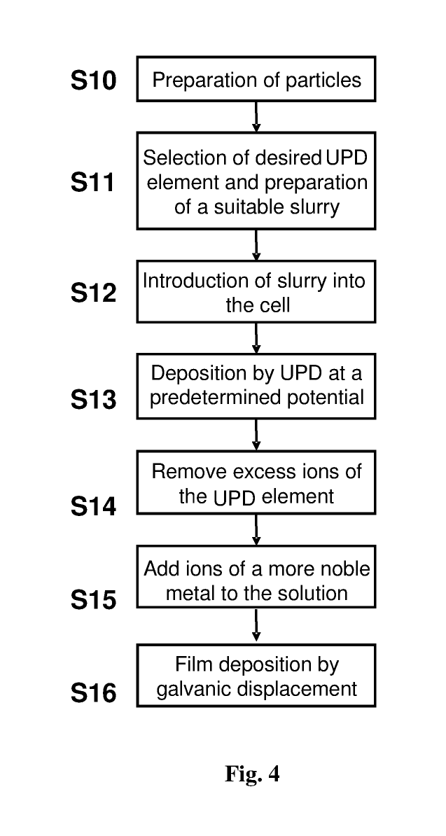

A generic description of UPD and galvanic displacement growth of ultrathin films using the cell will now be described in detail with reference to FIG. 4. The process flow illustrated in FIG. 4 is intended to describe a specific way of practicing the invention. However, it is to be understood that there are many possible variations which do not deviate from the spirit and scope of the present invention.

### Example 2

A second exemplary embodiment will now be described in detail with reference to FIG. 4 which shows the overall process flow for film growth by UPD and galvanic displacement using a cell. Initially, in step S10, particles of the desired composition, size, and shape are formed. Such particles may also be purchased from commercial vendors, such as E-TEK (39 Veronica Av., Somerset, N.J., 08873) and BASF (Germany). The particles used may be of any type onto which atomic layers of the desired material may be deposited. In a preferred embodiment the particles are of the type described in Section I above. Prior to deposition of an initial adlayer by UPD, it is necessary to prepare a slurry comprising ions of the desired UPD element as shown in step S11. The UPD element must be a material which exhibits underpotential deposition such as, for example, any of Cu, Pb, Bi, Sn, Ce, Ag, Sb, and Tl.

In step S12 the electrodes comprising the cell are introduced into the slurry solution. This may be accomplished, for example, by physically placing the electrodes into the cell as in a batch process or by initiating flow of the slurry as in a continuous process. Deposition by UPD proceeds by stirring the slurry at a predetermined stir speed using the magnetic stirrer/controller at 50 rpm stirring speed and applying the appropriate electrode potential (0.15 V) in step S13. If the process is in batch form, the slurry is stirred and the potential applied for a duration sufficient to form an adlayer on the desired fraction of particles. If the process is continuous, solution is continuously fed into and out of the cell where the desired fraction of particles are coated with an adlayer of the UPD element. In step S14, ions of the UPD element which are still in solution are removed such that ions of a more noble metal can be added in step S15. As in step S13, this can be done either in batch form or in a continuous manner. In step S16 the adsorbed atoms of the UPD element are replaced with atoms of the more noble metal by galvanic displacement to produce an ultrathin film of the noble metal. The process of galvanic displacement in step S16 may be accelerated by stirring the slurry at a speed sufficient to agitate the solution. After deposition, the particles are emmersed from solution, rinsed with deionized water and blown dry. Steps S11 through S16 can be repeated as desired to deposit additional layers onto the plurality of particles.

It is envisioned that a plurality of cells may be used to deposit ultrathin films onto a large number of particles in a manner suitable for operation on a commercial scale. When in batch form, there may be a plurality of separate stations for preparing a slurry, depositing an initial adlayer by UPD, rinsing the particles, forming an ultrathin film by galvanic displacement, and then rinsing and drying the particles. Alternatively, a continuously operating line with a plurality of cells may be envisioned. During operation, each of the steps provide in FIG. 4 may be performed at a different station.

In a preferred application, particles coated using the process described in this specification may be used as the cathode in a fuel cell. This application is, however, merely exemplary and is being used to describe a possible implementation of the present invention. Implementation as a fuel cell cathode is described, for example, in U.S. Patent Appl. Pub. No. 2010/0216632 to Adzic, et al. It is to be understood that there are many possible applications which may include, but are not limited to hydrogen sensors, charge storage devices, applications which involve corrosive processes, as well as various other types of electrochemical or catalytic devices.

It will be appreciated by persons skilled in the art that the present invention is not limited to what has been particularly shown and described hereinabove. Rather, the scope of the present invention is defined by the claims which follow. It should further be understood that the above description is only representative of illustrative examples of embodiments. For the reader's convenience, the above description has focused on a representative sample of possible embodiments, a sample that teaches the principles of the present invention. Other embodiments may result from a different combination of portions of different embodiments.

The description has not attempted to exhaustively enumerate all possible variations. That alternate embodiments may not have been presented for a specific portion of the invention, and may result from a different combination of described portions, or that other undescribed alternate embodiments may be available for a portion, is not to be considered a disclaimer of those alternate embodiments. It will be appreciated that many of those undescribed embodiments are within the literal scope of the following claims, and others are equivalent. Furthermore, all references, publications, U.S. Patents, and U.S. Patent Application Publications cited throughout this specification are hereby incorporated by reference as if fully set forth in this specification.

1. An apparatus for depositing ultrathin films on a plurality of nanoparticles comprising:
a cell for holding a slurry containing the plurality of nanoparticles and an electrolyte, the cell comprising an inner cell body made of an electrically conductive material serving as a cell body electrode,
a reference electrode,
a floating counter electrode, and
a stirring controller.

2. The apparatus of claim 1, further comprising a power supply configured to supply an applied potential to the electrically conductive material of the cell body.

3. The apparatus of claim 1, wherein the cell is made of a welded Ti sheet and the cell body is covered with RuO₂.

4. The apparatus of claim 1, wherein the power supply is operable to supply a voltage in the range of −1 to +1 Volts.

5. The apparatus of claim 1, further comprising a stirrer.

6. The apparatus of claim 5, wherein the stirrer is a magnetic stirrer or a mechanical stirrer.

7. The apparatus of claim 1, further comprising ultrasonic equipment

8. The apparatus of claim 1, wherein the floating counter electrode is disposed inside a counter electrode compartment which is adapted to float in the slurry containing the plurality of nanoparticles and an electrolyte.

9. The apparatus of claim 8, wherein the counter electrode compartment is made of glass.

10. The apparatus of claim 8, wherein the wherein the counter electrode compartment comprises fritted glass.

11. The apparatus of claim 8, wherein the wherein the counter electrode compartment is attached to polystyrene.
